(19) United States
(12) Patent Application Publication
(10) Pub. No.: US 2026/0338944 A1
(43) Pub. Date: Oct. 29, 2026

(54) THE DEVICE FOR RADAR SENSING OF THE GEOLOGICAL ENVIRONMENT

(71) Applicant: Andrey BERKUT, Haifa (IL)

(72) Inventor: Andrey BERKUT, Haifa (IL)

(21) Appl. No.: 19/117,623

(22) PCT Filed: Oct. 21, 2022
(86) PCT No.: PCT/IB2022/060144

§ 371 Date: Apr. 1, 2025

(51) Int. Cl. G01S 13/88; G01S 7/04; G01S 7/282; G01V 3/08

(52) U.S. Cl. CPC G01S 13/885; G01S 7/04; G01S 7/282; G01V 3/08

(57) ABSTRACT

A present invention refers to a class of geophysical devices intended for nondisturbing geological environment studies at depths of several tens to several hundreds of meters, with a radar comprising: transmitter configured to generate a high-voltage pulse and commutes it to the transmitting antenna located on the surface; transmitting antenna is consisted of sections with gaps, which is formed strips, wherein the gaps is consisted of nonmetalized sections of the antenna and metalized sections of the antenna are connected via damping resistors with different value of resistance, and wherein damping resistors are located on said gaps; wherein values of the resistors increase in the right and left parts and reach the maximum value at the end elements.

### FIELD OF THE INVENTION

The present invention (“Device”) refers to a class of geophysical devices intended for non-disturbing geological environment studies at depths of several tens to several hundreds of meters.

The device can be used to solve the problems of:
geology (in terms of mineral exploration, fault definition and delineation, hydrogeological investigations, engineering geology);
municipal engineering (search and mapping of underground utility systems, detection of watering zones and disturbance of the sub-soils structure);
construction expertise;
archeology;
ecology.

### BACKGROUND

At present, a number of devices for subsurface soil sounding are known which are based on the radar principles and named ground-penetrating radars (GPR). For example, as follows US 806795 A, published in 1974, US 490508 A, published in 1990, US 1562883 A1, published in 1990, US 1078385 A1, published in 1984, RU 2080622 C1, published in 1997.

The main disadvantages of these devices, which limit their wide application in the practice of geological exploration and engineering-geological surveys, are related to the fact that:
The devices have insufficient depth of sounding (the first ten meters) and cannot meet the needs of modern geophysics. Insufficient depth of sounding is related to the incomplete use of the transmitter power reserve and the “high frequency” of the frequency range of the antennas used;
The devices have insufficient dynamic range to record the sounding signal amplitude, which makes it impossible to use super high-power transmitters;
The devices have insufficient detail of digitization the sounding signal amplitude, which significantly reduces the GPR sensitivity while sounding at great depths;

The closest analogue is the device for radar sensing of the geological substrate—RU 2205424C1, published in 2003. According to RU 2205424 it is known the device for radar sensing of the geological substrate. The device comprising a transmitter made in the form of a spark gap, a transmitting antenna, a high-voltage power source and a storage capacitor, a receiver, which includes a receiving antenna, a limiter amplifier, a comparison unit, a memory unit, a two-dimensional indicator, a synchronization unit, a control unit, a control panel, while the control is made with the possibility of implementing the principle of stroboscopic registration of the reflected signal.

The main disadvantage is related to the use of the stroboscopic registration principle as the main element providing digitization of the received signal. The theoretical dynamic range of this type of recorder is 40 dB. In practical implementations, they have an even narrower dynamic range of registration. This significantly limits the practical depth of probing.

Present invention is disclosed “new device” which is a single geophysical complex, including:
Transmitter (TrU), consisting of a series-connected high-voltage power supply, storage capacitor and spark gap (FIG. 2);
Transmitting antenna;
Receiver (RcU), which includes attenuator, limiting amplifier, timing unit, analog-to-digital converter and main memory unit (FIG. 3);
Receiving antenna;
A single control unit (DDSU) (FIG. 5), which includes a block of long-time storage unit, a microprocessor and a two-dimensional LCD indicator, a control panel (keypad), interface to RcU and to external computer. The unit has a built-in rechargeable battery and a voltage regulation unit.

### SUMMARY OF THE INVENTION

The technical result of the patent invention is the “Device” (or “GPR”), i.e. a single geophysical complex executing a direct digitization of the received reflected signal, which is generated by super super high-power transmitters and emitted by low-frequency resistively loaded antennas.

Fundamentally new, elements of the claimed GPR are:
1) Using direct digitization of the received reflected signal. The fundamental difference between the executed digitization process and the standard one is that the signal with a dynamic range of amplitude variation is digitized to 120 dB (more than 1 000 000 times). Digitization of the received signal is executed with a sampling period of 1 to 8 nsec.
2) Introduction of large time bases of the reflected signal recording. The present device provides an option to work on large time bases from 4,096 to 20,000 nsec, which makes it possible to fulfill the superpower potential of the new device and work with signals in high-resistivity soils from depths of 200-300 to 1000 meters.
3) Equipping the claimed GPR with transmitters which commute the impulse voltage of 5, 10, 21, 50 and 100 kV to the antennas. Such power engineering of the claimed GPR allows us to talk about reaching the sounding depths in high-resistivity soils from 200-300 to 1000 meters.
4) Equipping the claimed GPR with low-frequency antennas. The frequency dependence of the sounding electromagnetic signal attenuation allows for achieving larger sounding depths in the same geological conditions, with the same transmitter power, but at lower frequencies. The new technical implementation of the claimed GPR is designed to work with antennas of 25 MHz (6 m), 15 MHz (10 meters), 10 MHz (15 meters) and 5 MHz (30 meters).
5) Including a built-in GPS receiver into the claimed GPR components. The position coordinates of the GPR receiver are measured with a given temporal and spatial detail. Measured coordinates are recorded in the protocol of each measurement.

In relation to the prototype, the present device implements a high-speed software-hardware algorithm that allows digitizing a signal with a dynamic range up to 120 dB and a sampling period from 1 to 8 nsec. Equipping the present device with super high-power impulse transmitters (5-100 kV), low-frequency antennas 5-25 MHz and built-in GPS receiver makes a new GPR implementation capable of solving geological problems in high-resistivity soils from 200-300 to 1000 meters.

It should be noted that present device may be used in Pola regions with gel lead batteries.

According to some embodiments a ground-penetrating radar for detecting objects under a surface, comprises: a transmitter (TrU) consisting of the connected power supply, low-voltage impulse generator, the receiver of a control signal via optical channel, high-voltage transformer, diode multiplier and rectifier, capacitor, spark gap, out of the transmitter antenna; a transmitting antenna; a receiver (RcU), which includes antenna amplifier, optical channel, Analog-to-digital converter, controlling device, random access memory; a receiving antenna; a data display and storage unit (DDSU), which includes a block of long-time storage unit, a microprocessor and a LCD display, a control panel, interface to the receiver (RcU) and to computer (PC); a rechargeable battery and a voltage regulation unit. The transmitter is located on the transmitting antenna and the receiver is located on the receiving antenna. The transmitter configured to generate a high-voltage pulse and commutes it to the transmitting antenna located on the surface. The transmitting antenna is consisted of sections with gaps, which is formed strips, wherein the said strips is consisted of non-metalized sections of the antenna. Metalized sections of the antenna are connected via damping resistors with different value of resistance. Damping resistors are located on said strips. Values of the damping resistors increase in the right and left parts and reach the maximum value at the end of elements.

The transmitter is connected with the receiver via nonmetallic frame.

A length of the strips may be 10 mm.

The ground-penetrating radar includes GPS.

### BRIEF DESCRIPTION OF THE DRAWINGS

FIG. 1—general flow diagram of the device for radar sensing of the geological environment:
FIG. 1A—mid-frequency version of the device “H” (Russian “B”) when frequency band is 50-300 MHz and with antennas of 200 MHz (wavelength-1 meter)
FIG. 1B—low-frequency version of the device “L” (Russian “H”) when frequency band is 1-50 MHz and with antennas of 50 MHz (wavelength-3 meters);

FIG. 2—flow diagram of the transmitter of the device for radar sensing of the geological environment;

FIG. 3—flow diagram of the receiver-recorder of the device for radar sensing of the geological environment;

FIG. 4—flow diagram of the ADC in the receiver-recorder of the device for radar sensing of the geological environment;

FIG. 5—flow diagram of the data display and storage unit;

FIG. 6—flow diagram of the antennas in the device for radar sensing of the geological environment:

FIG. 6A shows the scheme of 100 MHz antenna (1.5 meters).

FIG. 6B shows a flow diagram for constructing a 50 MHz antenna (3 meters).

FIGS. 7A and 7B shows the device operation.

The abbreviations and references used in the attached drawings:
TrU—transmitter of the device for radar sensing of the geological environment;
RcU—receiver of of the device for radar sensing of the geological environment;
DDSU—data display and storage unit;
ADC—analog-to-digital converter;
1—transmitting antenna;
2—receiving antenna;
3—power supply-12 volts battery,
4—low-voltage impulse generator,
5—the receiver of a control signal via optical channel,
6—high-voltage transformer,
7—diode multiplier and rectifier,
8—capacitor,
9—spark gap,
10—out of the transmitter antenna;
I—12 volts direct current,
II—low-voltage impulses of alternating current,
III—transformation to 1000-3000 volts,
IV—amplitude multiplication to 5000-21 000 volts, rectification,
V—charging by a series of impulses from the main capacitor up to the voltage of the spark gap trigger,
VI—triggering the spark gap (disruption), (200-1000 impulses per second);
11—antenna resistor;
12—metalized sections of antenna elements (metallization);
13—section with removed metallization (strips);
14—copper braid;
15—antenna contacts;
16—terminals and a socket to attach the TrU (transmitter)/RcU (receiver),
17—flexible connection of copper stranded wire,
18—central radiating element
19—four elements to the left of the central element
21—damping resistor R1,
22—damping resistor R2,
23—damping resistor R3,
24—damping resistor R4,
25—damping resistor R5,
26—damping resistor R6,
27—damping resistor R7,
28—damping resistor R8,
29—damping resistor R9,

### DETAILED DESCRIPTION

The transmitter (TrU) consists of the main series-connected units: power supply 3 with for example 12 volts battery, low-voltage impulse generator 4, the receiver 5 of a control signal via optical channel, high-voltage transformer 6, diode multiplier and rectifier 7, capacitor 8, spark gap 9, out 10 of the transmitter antenna.

Spark gap 9 consists of an arrangement of two conducting electrodes separated by a gap usually filled with a gas such as air.

In the transmitter, the signal undergoes the following main conversion steps:
I—12 volts direct current,
II—low-voltage impulses of alternating current,
III—transformation to 1000-3000 volts,
IV—amplitude multiplication to 5 000-21 000 volts, rectification,
V—charging by a series of impulses from the main capacitor up to the voltage of the spark gap trigger,
VI—triggering the spark gap 9 (disruption), (200-1000 impulses per second).

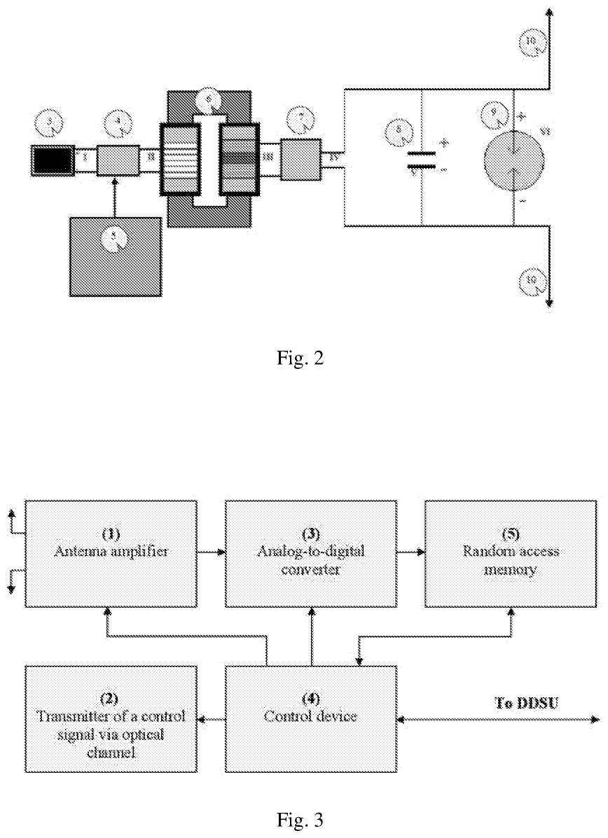

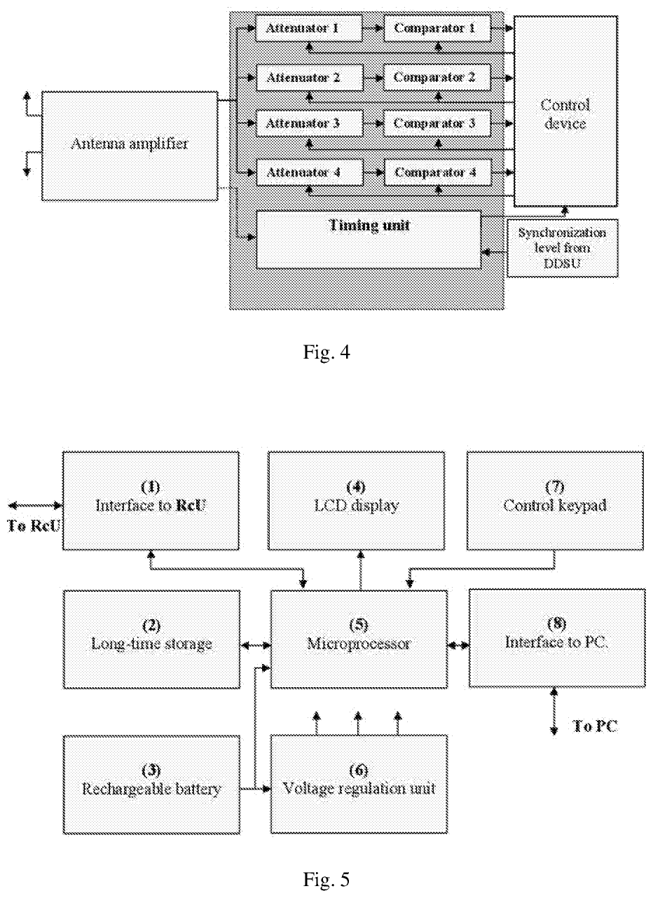

FIG. 3 shows the flow diagram of the RcU (receiver-recorder).
(1) Antenna amplifier provides adaptation of the input broadband signal to ensure normal operation of the digital unit of receiver. The antenna amplifier includes analog amplifiers and LF (low frequency) and HF (high frequency) filters providing the frequency band of the GPR receiver operation.
(2) Via the optical channel, the control signal unit transmits a command which switches the power part of the transmitter off for a period of time between measurements.
(3) Analog-to-digital converter (ADC) is implemented on four parallel channels, assembled from digital controlled attenuators and high-speed comparators. The reconstruction of the sounding signal waveform is performed by the threshold evaluation of amplitude executed in each of the time samples from the 1^{st} to the 512^{th}. The RcU operation is determined by the control signals from the data display and storage unit (DDSU) and depends on the mode set by the operator. A detailed DDSU flow diagram is shown in FIG. 4.

(4) The controlling device ensures the receiver operation, generation and sending a measurement data digital unit to DDSU.

(5) Random access memory. The main memory unit serves to generate the digital data of each measurement.

The main original RcU unit (receiver) is an analog-to-digital converter (FIG. 3, (block 3)). This unit implements a hardware-software algorithm that allows digitizing a signal with a dynamic range up to 120 dB.

FIG. 4 shows flow diagram of the ADC in the receiver-recorder of the device for radar sensing of the geological environment.

The “Timing unit” (FIG. 4) performs an important original function in the RcU (receiver). This unit carries out time matching of the measurements (digitization) start with the moment of sound impulse emission. The signal to the “Timing unit” comes from the antenna amplifier via a separate channel, bypassing the LF filter, forming the frequency band of the RcU (receiver). If a signal exceeding a preset threshold appears at the RcU (receiver) input, the timing unit generates a command to start recording. The level of the synchronization trigger threshold is selected so that it can be exceeded only by the signal from the device's own transmitter coming the distance between the antennas through the “air” (1 to 10 meters depending on the GPR modification). This “air” synchronization scheme allows you to exclude controlling the transmitter via a cable or wire, and significantly reduce the level of noise caused to the GPR receiver, practically exclude actuation of TrU unit by the external electromagnetic radiation sources.

The digitization function in the device's RcU (receiver) is fulfilled by multiple repeating the evaluation of the amplitude threshold values in each of the 512-time samples of the recording time base. The digitization process is performed on four parallel independent chains of attenuators and high-speed comparators (FIG. 4). In each cycle, new attenuation values are set, starting with “0 dB”. For example, in the first cycle after synchronization start: “Att. 1”—0 dB, “Att. 2”—2 dB, “Att. 3”—4 dB, “Att. 4”—6 dB. In the next cycle, which will be continued automatically: “Attenuator 1”—8 dB, “Att. 2”—10 dB, “Att. 3”—12 dB, “Att. 4”—14 dB, and so on by a logarithmic scale to 120 dB. Comparators 1-4 perform the signal amplitude evaluation according to the attenuation set in attenuators. The number of levels of the threshold amplitude evaluation is 128 or 255 (depending on the model). 5 pulses of the transmitter are needed for the signal amplitude evaluation by one of the 128 thresholds of the logarithmic scale. 5×128=640 pulses are needed to view all 128 thresholds. At a 1000 Hz pulse repetition frequency of a transmitter of 5 kV, one measurement cycle will be performed within a time interval of ~0.6 sec. The control device reconstructs the waveform according to the threshold evaluations and transmits the digital measurement data file to DDSU for archiving.

The hardware-software algorithm implemented in the device's RcU (receiver) allows to digitize a signal with a dynamic range up to 120 dB without additional “manual” or automatic gain adjustment systems for the analog input path.

FIG. 5 shows the flow diagram of DDSU (data display and storage unit):
(1) The interface to RcU manages recording parameters, receives and controls digital measurement data files.
(2) Long-time storage serves for storage of digital measurement data files. The device memory is non-volatile.
(3) RB (rechargeable battery) provides power to DDSU and RcU. Lead-acid battery, hermetic type. The battery ensures reliable operation of the device at negative temperatures. The battery voltage is 12 V, and the capacity is 3.2-7 A/hour.
(4) LCD. The contrast adjustment of the device display ensures operation at temperatures of minus 20 °C to plus 50 °C.
(5) Microprocessor. Microprocessor provides the archiving of measurement results, screening of the GPR cross-section in real-time measurements, and viewing the measurements results from the device's memory.
(6) Voltage regulation unit. The unit ensures the generation of all stabilized supply voltages required for the operation of RcU and DDSU.
(7) Control keypad (control panel). The modern splash-proof keypad serves for the input of the necessary data and device control.
(8) Interface to personal computer (PC). The interface provides the formation of digital data files and the option to transfer data to an external computer using the USB bus protocol.

An important element of the GPR is the antennas. All antennas of the GPR are designed by the resistively-loaded electric dipoles type. The antenna length is half the wavelength at the maximum of the spectrum of the emitted broadband signal in the air. The main constructive feature of antennas is resistive damping, performed according to the Wu-King principle [1] [T. T. Wu, R. W. P. King. The Cylindrical Antenna with Nonreflecting Resistive Loading. IEEE Transactions on Antennas and Propagation. May 1965. V. AP-13, N.3.].

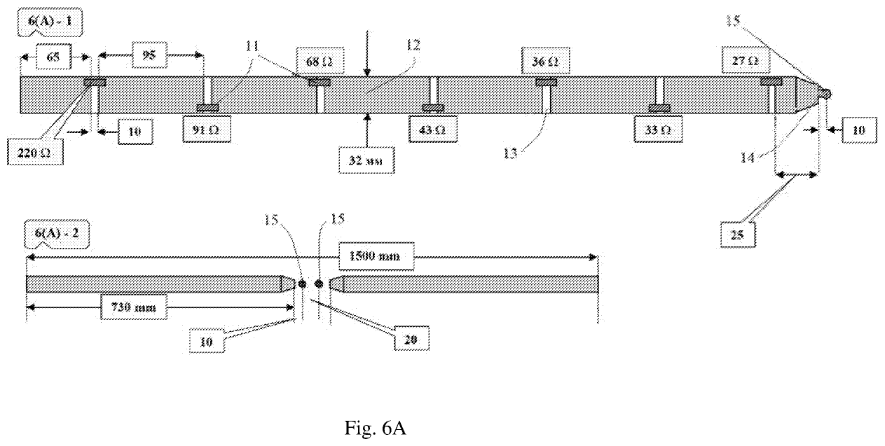

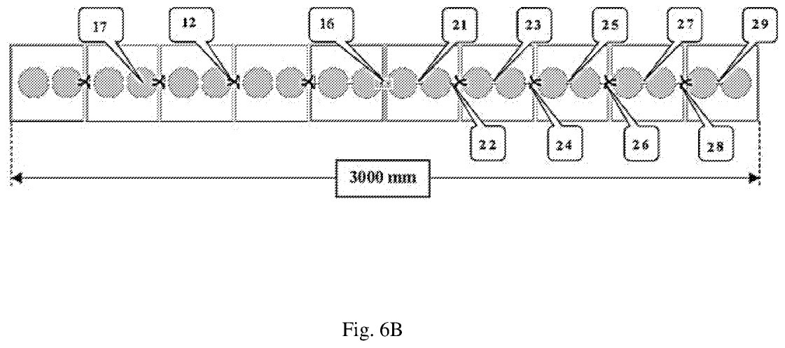

FIG. 6 shows the flow diagram of the GPR antennas:

FIG. 6A presents the 100 MHz antenna scheme (1.5 meters). In the upper part (6A-1)—a diagram of the “left” wing of antenna is shown, indicating the locations and ratings of damping resistors. The “right” wing of the antenna is identical to the “left” one. In the bottom part of the FIG. 6A-2, a general scheme of 100 MHz antenna (1.5 meters) is shown. The 200, 300 and 400 MHz antennas are built according to the same scheme.

The numerical symbols on FIG. 6A shows the size in millimeters (mm), the symbol Ω shows the amount of resistance (ohms).

FIG. 6B presents a flow diagram for constructing a 50 MHz antenna (3 meters). The antenna consists of a central radiating element 18 and four elements 19 to the right and left of the central element. The central element is indicated on the FIG. 6B as 18. Four elements to the left of the central element 18 are indicated as 19 and four elements to the right of the central element are indicated also as 19 accordingly (see FIG. 6B).

Usually the antenna is made of fiber-glass plastic with one-sided metallization. When metallization is removed, an insulator (fiber-glass plastic) remains between the antenna elements. The resulting discontinuities of the solid conductor along the antenna are connected by resistors. The nominal values (resistance value) of the resistors increases from the center of the antenna in two directions to the ends. This is the principle of damping a broadband antenna.

The damping resistor ratings and the element sizes for all antenna types are calculated according to Wu-King engineering formulas from [1].

Antennas of 25 MHz (6 meters), 15 MHz (10 meters) and 10 MHz (15 MHz) are built according to the same scheme. Each antenna has its own range of damping resistor ratings.

All antennas of georadar belong to the type of half-wave electric dipoles. The frequency of the signal that is most effectively emitted and received by such an antenna is determined by the length of the antenna. The most optimal frequency are corresponded to the wavelength of the electromagnetic signal equal to twice the length of the antenna, for example, the antenna length of 1.5 meters—the wavelength of 3 meters—the frequency of 100 MHz.

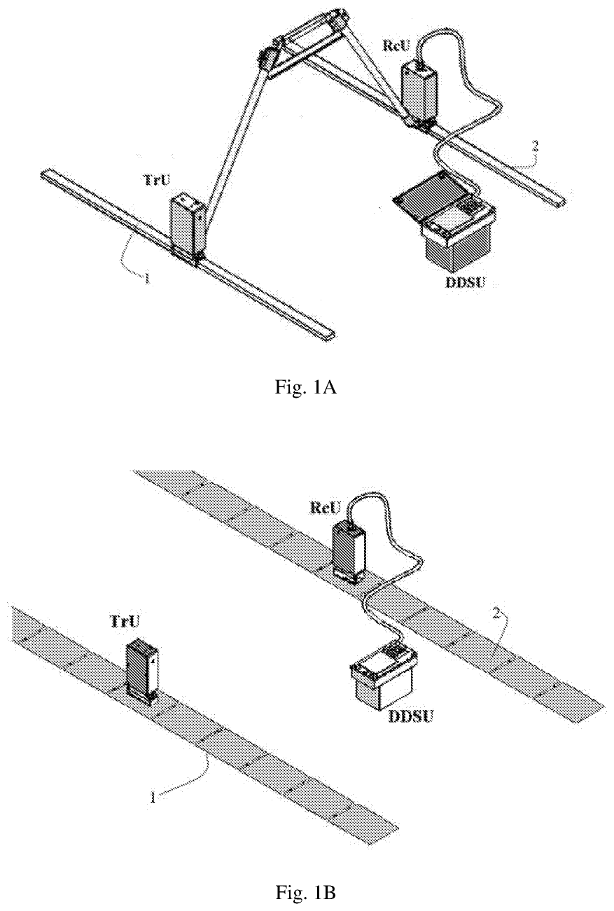

FIG. 6A (lower part) shows a general view of an antenna with a length of 1.5 m (100 MHz). The antenna of the emitter (transmitter) is powered through two contacts in the central part of the antenna. The right contact is connected to the right quarter-wave element, the left contact is connected to the left element. A recorder (receiver) is connected to the central terminals on the receiver antenna. In a half-wave dipole of the simplest design, the right and left antenna elements are solid metal conductors. With “shock” excitation in the emitter (transmitter) of a high voltage pulse, weakly damped resonant phenomena occur in the antenna. A short nanosecond pulse generated by the transmitter is converted into a signal with multiple repetitions. Probing with multiple repetitions of the emitting pulse is not possible. To eliminate this, damping (attenuation) is introduced into the design of the half-wave electric dipole. Each of the antenna elements (right and left parts) are divided into sections by insulating gaps. In practice, this is realized by removing the strips 13 with lengths 10 mm of metallization between the antenna sections. The metalized sections 12 of antenna elements are divided by strips 13 and the metalized sections 12 of antenna elements are connected by damping resistors with various amount of resistance. The values of the damping resistors for each type of antenna are calculated exponentially. In the center there are minimum resistance resistors. The values of the resistors increase in the right and left parts and reach the maximum value at the end elements. This can be seen at FIG. 6A-1: 27, 33, 36, 43, 68, 91, 220 ohms.

Thus, the transmitting antenna is consisted of sections with gaps which is formed strips 13. Each strips 13 is consisted of non-metalized sections of the antenna i.e. metallization is removed on the strips 13. Metalized sections 12 of the antenna are connected via damping resistors with different value of resistance. Thus, damping resistors are located on said strips.

Values of the damping resistors increase in the right and left parts (see upper drawing in FIG. 6A) and reach the maximum value at the end of antenna.

The use of damping resistors makes it possible to convert a traditional half-wave electric dipole into a broadband non-resonant antenna for the georadar. In this case, the antenna length reflects the center frequency of the broadband signal spectrum. All georadar antennas are made identically, only the calculated dimensions of single antenna sections and the values of damping resistors differ.

FIG. 6B shows a 50 MHz antenna circuit (length 3000 mm or 3 m). This is the same half-wave electric dipole, the single antenna sections of which are made in the form of metallization circles (Ø 15 cm). The single sections are connected by damping resistors 21-29. There are two sections on solid fiberglass boards (30×30 cm). The sections are placed on a PVC tape base and are electrically connected to each other by flexible copper cables. This design allows you to fold an antenna with a length of 3 meters into a transport state with a size of 0.3×0.6×0.1 meters.

According to the scheme in FIG. 6A, GPR antennas of 400, 200, 100 MHz are constructed. According to the scheme in FIG. 6(B)—50, 25, 15 and 10 MHz.

Operational scheme of the “GPR”:
1. The transmitter (TrU) generates and commutes the pulses of 5-100 kV to the transmitting antenna with a pulse repetition frequency of 200-1000 l/s;
2. When a measurement command is emitted (the “START” button on DDSU), the receiver (RcU) starts recording from the moment when the “air” synchronizing signal comes that exceeds the synchronization level threshold set in DDSU;
3. The receiver (RcU) receives the reflected signal and reconstructs the signal waveform by multiple repeating the evaluation of the amplitude threshold values in each of the time samples of the recording time base. The receiver (RcU) reconstructs the waveform according to the threshold evaluations, generates and transmits the digital measurement data file to DDSU for archiving;
4. DDSU generates a measurement data file by a profile of individual step-by-step measurements, writes this file into memory, and allows you to transfer the data to an external computer (laptop) or view measurement results in real-time measurements on the LCD.

The key constructional elements of the present GPR are following:
the main key constructional elements of the present GPR which allow obtaining record-high results on the sounding depths of the geological environment are as follows:
development and use of super-power transmitters in the present GPR which commute to antennas 5 to 100 kV,
the use of resistively-loaded dipoles as antennas, which allows to fulfill the full power of the transmitters and to obtain non-periodic, non-oscillating sounding signal,
development and use of the hardware-software algorithm that performs the function of ADC in the device's RcU (receiver), which allows to fulfill the full power of the transmitters and to digitize a signal with a dynamic range up to 120 dB without additional “manual” or automatic gain adjustment systems for the analog input path,
the use of low-frequency antennas allows to shift the maximum of the spectrum of the emitted signal to the area of lower attenuation values of the electromagnetic signal, which provides the possibility to significantly increase the depth of sounding.

Record-breaking depth characteristics are achieved due to a combination of factors that are used for the first time in a complex:
the transition to lower frequencies (10-25 MHz) of the broadband signal provides probing in conditions of significantly lower linear attenuation of the radio signal;
the use of a digital registration system based on high-speed comparators provides a dynamic range of signal registration of more than 120 db (modern ADC chips do not provide the necessary dynamic range);
the use of a logarithmic registration scale makes it possible to noticeably increase sensitivity in the range of small signal amplitudes,
the design features of antennas that ensure operation in close contact with the earth's surface form the maximum possible signal energy directed to the lower hemisphere (earth).
the use of heavy-duty 20-100 kV transmitters together with 10-15 MHZ antennas provide record-breaking performance in depth sensing,
the implementation of probing with a minimum number of generated pulses (without averaging and accumulation) and a large range of signals (a large time interval between pulses at a minimum pulse duration) provide a level of external radiation that meets all environmental standards.
the use of gel lead batteries may provides the necessary capacity of GPR batteries at low temperatures in the Arctic and Pola regions.

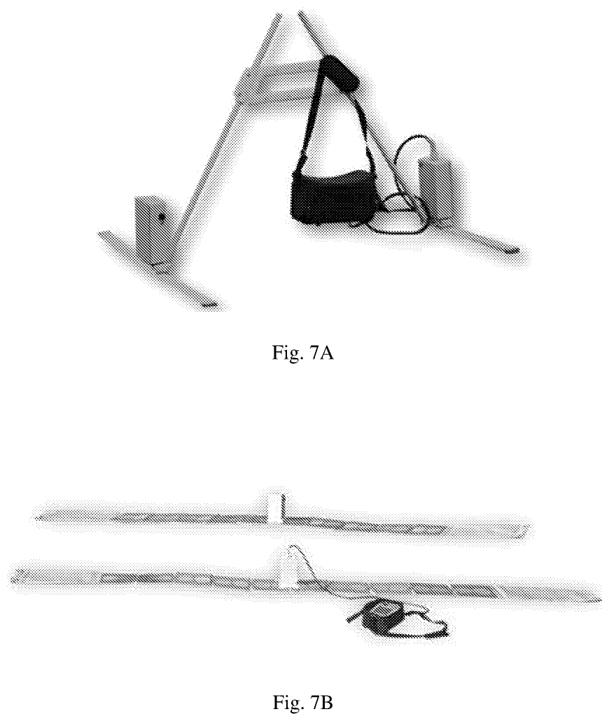

FIGS. 7A and 7B shows georadar operation.

Georadars of belong to the class of geophysical instruments for studying the subsurface structure and structure of soils at depths from units to hundreds of meters, depending on the model of the device, the antennas used, emitters and parameters of the probed medium.

The principle of operation of georadars is based on the emission of ultra-wideband electromagnetic pulses without a carrier into the underlying medium and the registration of their reflections from the interface of layers or the surface of underground objects with different values of permittivity. Part of the energy of the probing signal is reflected from the boundary of the media, the receiver receives the reflection and records the time of arrival of the signal. Part of the energy of the probing signal passes through the boundary and is reflected from the underlying ones.

The georadar provides a display of the recorded reflected radio pulse at the measurement point and the traversed part of the geological profile on the liquid crystal indicator (LCD) of the information display unit. Directly on the LCD screen during the survey, it is possible to trace the boundaries of the geological layers in real time; to make a preliminary field measurement of the depth of occurrence and removal from the beginning of the profile of underground inhomogeneities, various objects and objects in the geological environment (utilities, foundations, etc.).

The transmitting and receiving device make it possible to emit, receive and process radar signals of increased power (>1 MW), which makes it possible to work in environments with high absorption (clays, loams, including wet ones).

Damped resistively loaded dipoles (Wu-King antennas) are used as antennas (or their main radiating elements) in GPR radars. This ensures that there is no “ringing” in the received signal.

Synchronization of the receiver in the GPR occurs by an air wave. The independent design of the transmitter and receiver allows for “probing”, i.e. the construction of a hodograph. In this case, the points of reception and transmission of the electromagnetic pulse are sequentially spaced. This method is the main one for determining the true depth of the roof of the layer or the top of the object, as well as the propagation velocity of the electromagnetic pulse in the layers of the geological section, i.e. the parameters of the medium itself.

The ground-penetrating radar is assembled on the surface of the investigated area in accordance with the operating instructions (FIGS. 7A and 7B). The antennas of the device are installed in parallel, at a distance of about the length of the antenna used. In the case of the medium-frequency version of the device, the receiver and transmitter are connected by a non-metal frame (FIG. 7A). In the low-frequency version, the antenna and transmitter are not connected to the antenna and receiver of the ground-penetrating radar, because depending on the tasks and conditions of the survey, the antennas can move along the profile parallel to each other, sequentially and at different distances from each other.

The measurement process consists of a short to (1 sec) stop, at the moment of stopping the “start” button is pressed and the measurement takes place. Further, the antennas of the device are moved (manually in conditions of difficult terrain or towed behind a car) with the selected step (in the case of engineering communications, the measurement step is 10-20 cm, when examining small-scale geological structures, a step of 30-50 cm is recommended and for large-scale structures—50-100 cm) and the measurement process is repeated. The final result is a set of wave forms (in digital form), measured step by step over the entire profile. The measurement result is recorded in the device's memory and can be analyzed from the screen during the measurement process or after the work is completed by displaying information from memory on the screen. Information from the device's memory is transferred to the PC via a USB connector. The information contains GPR sensing data, the time of each measurement and the coordinates of each measurement obtained using GPS. The measurement results on the control panel are processed, interpreted and up to the reporting radarograms using special software.

The process of GPR sounding on the surface of soil, snow, ice is performed according to one technique and without additional accessories. The process of sounding from the surface of freshwater reservoirs is possible only with the use of special sealed floating covers.

Following steps are performed by georadar device during the operational period.
1) The transmitter (TrU) generates a high-voltage pulse and commutes it to the antenna located on the surface of the soil.

The pulse of the transmitter is a voltage jump from the breakdown voltage of the spark gap (5, 10 or 21 kV) to zero in fractions of nanoseconds.
arriving at the antenna terminals, the voltage surge is converted into a broadband pulse of the aperiodic type (non-resonant type). The maximum of the spectrum of radiated energy will be concentrated at the frequency corresponding to the length of the electromagnetic wave equal to twice the length of the antenna.
2) Most of the energy is radiated into the geological environment. Part of the energy is radiated into the airspace.

The pulse signal emitted into the airspace reaches the receiving antenna over the shortest distance and starts the recording process using the timing unit.

The part of the energy that is radiated into the upper hemisphere (into the airspace) is proportional to 1/(n+1)². The part of the energy that is radiated into the lower hemisphere (into the geological environment) is proportional to n²/(n+1)².

The value n=√ε is called the refractive index where: ε is the dielectric constant of the medium.

Comparing estimates of the energy radiated into the upper (P₂) and lower (P₁) hemispheres, it can be obtained that n² times more is radiated down than up. For the conditions of the middle climatic zone of Europe, no more than 10% of the total radiated georadar energy (P₀) will be emitted upwards on clay soils of average humidity. When probing very wet soil or fresh water, about 1% of the total radiated GPR energy (P₀) will be emitted into the upper hemisphere.

The geological environment in the case of a georadar antenna is an integral part of it and determines the radiation pattern.

Part of the signal emitted into the air (less than 10% of the total energy) is a hindrance, but performs a useful function. Passing through the “air” over the shortest distance, this part of the signal performs the function of synchronizing the receiver and “contactless” starting the process of registering the reflected signal.
3) The useful part of the energy of the probing signal is distributed into the medium under study. At the boundaries contrasting in dielectric permittivity and conductivity, part of the signal is reflected and received by the receiver with a fixed propagation time. Part of the energy of the probing signal passes through the reflecting boundary and is reflected from the underlying ones. The georadar receiver generates a time scan of reflections from the boundaries in the medium under study. The amplitude-phase characteristics of the signals from the boundaries at different depths reflect the properties of the medium at a qualitative level. After moving the receiver and transmitter antennas to the next point (at the measurement step), the sensing process is repeated. From the wave forms of registration at each individual point, a georadar profile is formed.
4) An analog-to-digital converter in the receiver unit (RcU) generates a waveform file of the reflected signal amplitudes and archives it in the long-time storage of the control unit (DDSU).

The analog-to-digital converter in the receiving unit (RcU) provides digitization of the amplitude of the received signal in the entire dynamic range and the formation of a file of amplitude-phase characteristics with the necessary sampling period and coordinates of measurement points. The measurement file is archived in the memory of the control unit and transferred via USB to a computer for further processing, interpretation and preparation of reporting materials.

1. A ground-penetrating radar for detecting objects under a surface, comprising:
a transmitter (TrU) consisting of the connected power supply, low-voltage impulse generator, the receiver of a control signal via optical channel, high-voltage transformer, diode multiplier and rectifier, capacitor, spark gap, out of the transmitter antenna;
a transmitting antenna;
a receiver (RcU), which includes antenna amplifier, optical channel, Analog-to-digital converter, controlling device, random access memory
a receiving antenna;
a data display and storage unit (DDSU), which includes a block of long-time storage unit, a microprocessor and a LCD display, a control panel, interface to the receiver (RcU) and to computer (PC);
a rechargeable battery and a voltage regulation unit;
wherein the transmitter is located on the transmitting antenna and the receiver is located on the receiving antenna;
the transmitter configured to generate a high-voltage pulse and commutes it to the transmitting antenna located on the surface;
the transmitting antenna is consisted of sections with gaps, which is formed strips, wherein the strips is consisted of non-metalized sections of the antenna, and metalized sections of the antenna are connected via damping resistors with different value of resistance, and wherein damping resistors are located on said strips; and
wherein values of the said damping resistors increase in the right and left parts and reach the maximum value at the end of antenna.

2. The radar according to claim 1, wherein the transmitter is connected with the receiver via nonmetallic frame.

3. The radar according to claim 1, wherein a length of the strips is 10 mm.

4. The radar according to claim 1, wherein further including GPS.
